(19) United States
(12) Patent Application Publication
(10) Pub. No.: US 2018/0033081 A1
(43) Pub. Date: Feb. 1, 2018

(54) AUCTION MANAGEMENT SYSTEM AND METHOD

(71) Applicant: Aristotle P.C. Karas, Denver, CO (US)

(72) Inventor: Aristotle P.C. Karas, Denver, CO (US)

(21) Appl. No.: 15/661,503

(22) Filed: Jul. 27, 2017

Related U.S. Application Data
(60) Provisional application No. 62/367,632, filed on Jul. 27, 2016.

(51) Int. Cl. G06Q 30/08

(52) U.S. Cl. CPC G06Q 30/08

(57) ABSTRACT

A method and system for operating an auction over a computerized network. The method/system includes: requesting, analyzing and recording personality data information from a bidder to determine a personality type; associating the determined personality type to a bidder account; providing a computerized library of notification messages that include a multiplicity of notification messages for auctions that each include information presented according to a communication style that is crafted to promote taking action by a particular personality type and associated within the computerized library with that particular personality type; automatically generating a notification for the bidder based on an event that occurs within the computerized auction system; automatically generating a custom notification message for the bidder from the computerized library of notification messages based on the notification in combination with the determined personality type of the bidder; and/or presenting the custom notification message to the bidder over a user interface.

### CROSS-REFERENCE TO RELATED APPLICATIONS

This invention claims priority, under 35 U.S.C. §120, to the U.S. Provisional Patent Application No. 62/367,632 by Karas tiled on 27 Jul. 2016, which is incorporated by reference herein in its entirety.

### FIELD OF THE INVENTION

The present invention relates to management systems, specifically to an auction management system and method.

### DESCRIPTION OF THE RELATED ART

Auctions are used to move merchandise and services in a social setting. Generally, a collection of items/services for sale are presented to a group of prospective buyers, who then bid against each other to secure purchase of the same. Where something is particularly desirable to two or more parties, the price then, generally, escalates to the point just above the highest amount that the second to last party to exit the process is willing to pay. Accordingly, the seller is able to secure a higher sale value, which the buyer is often able to pay less than the maximum of what they were willing to spend.

Auctions are generally run by an auctioneer, especially wherein the process takes place in a single location in front of a group of prospective buyers. However, other systems and structures have been developed to allow for variety in how auctions can take place.

Some auctions now take place online. Examples include so-called “penny auctions” where bidders pay a small amount to place a bid through an electronic system online. The actual bids tend to be a fraction of the value of the item, but, since all bidders lose the amount they paid to place their bid, the amount collected from all the bidders can far exceed the value of the item.

In another example, sellers post items for bid on a website (e.g. www.eBay.com) where prospective buyers from all over the world can view the item and potentially bid. The systems generally include ways for bidders to communicate with sellers, buyer/seller reviews, and search tools that allow users to look for similar offers.

Silent auctions are a type of auction where the bidding process is not announced for each item, but instead bidders “visit” the items or a bid-sheet that represents the item and are able to place bids on those items, generally in writing. They often include a system for allowing bidders to be anonymous, such as assigning each bidder a number that they can record next to each bid they make. As bidders circulate around a collection of items, they are able to place bids and outbid each other until time for bidding is over and the bidding sheets are reviewed to see who wins the bids.

Auction systems sometimes have a method of notifying bidders that their bid has been “outbid” by someone else. Some systems do not, for example many silent auction systems have no notification process and bidders are sometimes surprised that they have not won. Such systems also have a notification process for notifying winning bidders of their win and also their obligation to make good on their bid. Such notifications help promote the healthy functioning of those processes.

Auction systems must be accurate and provide timely, accurate, and complete information in order for the participants to feel as though the auction has been conducted fairly. Accordingly, the notifications and notification system must meet those needs. Accordingly, many notification systems that may be useful or relevant to other types of computerized systems may not be relevant, useful, appropriate, and/or recommendable for use in auction systems.

Various systems and methods have been developed in the field of auctions, auction management, bid notification, notifications in general, and similar fields. Examples of references related to the present invention are described below in their own words, and the supporting teachings of each reference are incorporated by reference herein:

U.S. Pat. No. 8,326,693, which teaches systems, methods and computer program products for processing inputs of various formats to be used in an auction are described. In some implementations, a conversion application can be used to assist a user in setting a conversion ratio by which a service can be valued (e.g., for converting values between commercial and proprietary currency). In some implementations, a cash value of the service to be rendered can be defined. In these implementations, the conversion application can facilitate the determination of an appropriate conversion ratio by which the cash value can be converted to other currency value (e.g., to other proprietary currency);

U.S. Pat. No. 8,285,564, which teaches a solution to determining an interaction between objects through wireless tracking. Utilizes communication devices attached to objects that transmit signals for reception by sensors stationed throughout a facility which forward the signals to an information engine for analysis;

U.S. Pat. No. 8,082,151, which teaches an automated method of and system for generating a response to a text-based natural language message is disclosed. The method includes identifying a sentence in the text-based natural language message. Also, identifying an input clause in the sentence. Further, comparing the input clause to a previously received clause, where the previously received clause is correlated with a previously generated response message. Additionally, generating an output response message based on the previously generated response message. The system includes means for performing the method steps;

U.S. Pat. No. 7,996,372, which teaches an automated correspondence response system is provide for permitting a receiving entity to generate customized responses based on data extracted from received communications. The system also provides for automated management and manipulation of data extracted from correspondence received by a receiving entity for group profiling and to perform various statistical analysis thereof. The system analyzes content of received correspondence, such as celebrity fan mail, and manages the automation of responses via targeted or “customized” letters, wherein the receiving entity creates content specific fields or terms in order to respond to correspondence in an automated and yet relevant manner. The receiving entity can electronically define what data is extracted from the correspondence. A particular “customized” response to the correspondence may be electronically selected from a plurality of possible responses based on the data extracted from the sender's correspondence so that the receiving entity can effectively respond to the sender. The “customized” automated response can also be “personalized” by including sender specific data in the “customized” automated response;

U.S. Pat. No. 7,475,109, which teaches an interface is provided to the user of an e-mail client program. The interface allows the user to organize his or her contacts into categories and may display representations of the user's e-mail contacts in a manner that indicates to which category the contacts belong. The user may use the interface to set customized auto-reply messages on a per-category basis, or otherwise;

U.S. Pat. No. 7,272,575, which teaches a computer-implemented method and system for facilitating service transactions, both on-line and off-line, for transacting services driven by purchasers or by service providers. In particular, it makes services freely tradable as goods via standardizing material terms describing such service transactions. The method includes steps defining a set of service classification and material terms, registering a plurality of participants of the service marketplace, searching and compiling at least one offer and one request for offers provided by the participants for selling or buying services while the offer and the request for offer is described in the set of service classification and material terms, evaluating and matching the offer and the request for offer based upon the degree of identicalness of the set of service classification and material terms recited in the offer and the request for offer, and communicating to matched participants of the result generated by the evaluating and matching step;

U.S. Pat. No. 6,795,808, which teaches an interaction simulator, such as a chatterbot, is connected with an external database, such as an electronic program guide. The information gathered during interaction, particularly conversational, is parsed and used to augment the database data. The interaction simulator may be guided by the data residing in the database so as to help fill in recognizable gaps by, for example, intermittently asking questions relating to the subject data requirement. The interaction simulator may be provided with specific response templates based on the needs of the database and a corresponding set of templates to extract the information required by the database. Another example database may be for recording and indexing by key word stories or other free-form verbal data uttered by the user. The interaction simulator may he programmed to help the user develop the story using templates designed for this purpose;

U.S. Pat. No. 6,731,307, which teaches an interaction simulator uses computer vision, and inputs of other modalities, to analyze the user's mental state and/or personality. The mental state and/or personality are classified and this information used to guide conversation and other interaction. In a chatterbot embodiment, the substance of the conversation may be altered in response to the mental state and/or personality class, for example, by changing the topic of conversation to a favorite subject when the user is sad or by telling a joke when the user is in a good mood;

U.S. Pat. No. 6,718,368, which teaches a process and system is disclosed for automatically and adaptively retrieving information from a database and transmitting reply messages based on the content of a received message, such as an e-mail, CGI form, or facsimile document. In one step of the process, an enhanced e-mail editor user interface is employed to display the original message, the system's adaptive analysis results, and the automatically generated reply message so that a user may review the reply, modify the analysis results, and modify the reply message. The process then learns the changes indicated, and updates the adaptive analysis steps which analyze the received messages. In so doing, future reply messages are increasingly more accurate and correct. After the is adaptive algorithms have been sufficiently trained through the user intervention and correction step, the process and system disclosed is capable of fully autonomous reply generation and transmission;

U.S. Pat. No. 6,212,502, which teaches a computer user interface including an observer capable of observing user behavior, an agent capable of conveying emotion and personality by exhibiting corresponding behavior to a user, and a network linking user behavior observed by said observer and emotion and personality conveyed by said agent. The network can include an observing network facilitating inferencing user emotional and personality states from the behavior observed by the observer as well as an agent network facilitating inferencing of agent behavior from emotion and personality states to be conveyed by the agent. In addition, a policy module can dictate to the agent network desired emotion and personality states to be conveyed by the agent based upon user emotion and personality states inferred by the observing network. Typically, each network is a stochastic model. Each stochastic model is preferably a Bayesian network, so that the observing network is a first Bayesian network while the agent network is a second Bayesian network. Generally, the first and second Bayesian networks are similar copies of one another. Each of the two Bayesian networks include a first layer of multi-state nodes representing respective emotional and personality variables, and a second layer of multi-state nodes representing respective behavioral variables. Each one of the nodes includes probabilities linking each state in the one node with states of others of the nodes. More specifically, each one of the nodes in the first layer includes probabilities linking the states of the one first layer node to the states of nodes in the second layer. Similarly, each one of the nodes in the second layer include probabilities linking the states of the one second layer node to states of nodes in the first layer;

U.S. Pat. No. 5,987,415, which teaches a computer user interface including an observer capable of observing user behavior, an agent capable of conveying emotion and personality by exhibiting corresponding behavior to a user, and a network linking user behavior observed by said observer and emotion and personality conveyed by said agent. The network can include an observing network facilitating inferencing user emotional and personality states from the behavior observed by the observer as well as an agent network facilitating inferencing of agent behavior from emotion and personality states to be conveyed by the agent. In addition, a policy module can dictate to the agent network desired emotion and personality states to be conveyed by the agent based upon user emotion and personality states inferred by the observing network. Typically, each network is a stochastic model. Each stochastic model is preferably a Bayesian network, so that the observing network is a first Bayesian network while the agent network is a second Bayesian network. Generally, the first and second Bayesian networks are similar copies of one another. Each of the two Bayesian networks include a first layer of multi state nodes representing respective emotional and personality variables, and a second layer of multi-state nodes representing respective behavioral variables. Each one of the nodes includes probabilities linking each state in the one node with states of others of the nodes. More specifically, each of the nodes in the first layer includes probabilities linking the states of the one first layer node to the states of nodes in the second layer. Similarly, each one of the nodes in the second layer include probabilities linking the states of the one second layer node to states of nodes in the first layer;

U.S. Pat. No. 6,418,440, which teaches a customized method or algorithm for holding an interactive dialogue session between a (human) user and a machine (hereinafter referred to simply as a “dialogue”) is generated, such that the resulting dialogue advantageously responds to the user's requests and wherein the system's capability (i.e., the dialogue) is automatically modified thereafter based on dynamically changing external databases. Specifically, a computer system acts as a Dialogue Generator agent by creating such a customized dialogue consisting of services that are organized and presented in a form that is a combination of the user's expectations and the system's capabilities. In particular, the system's capabilities advantageously include the information content of database/service providers (such as, for example, a distributed information source such as the World Wide Web or a corporate file system), and the Dialogue Generator advantageously modifies the dialogue periodically in response to this dynamically changing external environment;

U.S. Patent Publication No.: 2012/0284080, which teaches computing values of cognitive and personality indicators of users of a telecom operator by means of machine learning and data mining algorithms from information available in a telecom operator system extracted from Social Network Analysis metrics, Call Detailed Record information and commercial information of said users stored in an operator's Data Warehouse and Customer Relationship Management systems as well as information from previous surveys, or questionnaires, answered by a representative sample of users as an input of said machine learning and said data mining algorithms. The method involves building a complex computer model that infers the values of the psychological dimensions of said users by means of said machine learning and said data mining algorithms to obtain a multi-dimensional vector for each of the users;

U.S. Patent Publication No.: 2011/0276377, which teaches a communication system with client devices in communication with at least one communication network. User data stores are also in communication with the communications network and store user data of users using respective ones of the client devices. Offer data stores also in communication with the communications network store offers from merchants. A narrowcasting engine includes an active data gathering module to collect the user data, and an active learning module to generate a user profile based on the user data. The communication engine selects dynamically offers from the offer data store based on the profile, and communicates the selected offers in the offer data store to the users;

U.S. Patent Publication No.: 2011/0082687,which teaches a computer-based system receives and analyzes digital communication between at least one party in a business enterprise and another party using a natural language analyzer to extract meanings from the message. The system includes a database storing specific actions to be taken upon the detection of specified meanings in such communications. Certain actions may require the system to interrogate the enterprise computer system's database to locate the existence or nature of specified data. The directed actions take the form of communications within an enterprise to assist activities related to the analyzed digital communication;

U.S. Patent Publication No.: 2009/0172077, which teaches an apparatus for delivering a message to a user comprising means for communicating with service providers and means for communicating with device agents operating on respective user devices, wherein the service provider communicating means is configured to receive a request to communicate with a specified user and to selectively output a message for the user to said device agent communicating means and wherein the device agent communicating means is configured to maintain a list of connected device agents, to receive said message and to transmit said message to a selected device agent dependent upon a routing policy for said user;

U.S. Patent Publication No.: 2004/0138959, which teaches a platform for authoring and deploying interactive characters which are powered by artificial intelligence. The platform permits the creation of a virtual world populated by multiple characters and objects, interacting with one another so as to create a life-like virtual world and interacting with a user so as to provide a more interesting and powerful experience for the user. This system can be used for entertainment purposes, for commercial purposes, for educational purposes, etc.;

U.S. Patent Publication No.: 2011/0054985, which teaches a method of accessing a set of responses to an instrument for assessing a communication style of a person; based on the set of responses to the instrument, determining a communication profile of the person that indicates how the person mentally processes information, how the person mentally organizes information, how comfortable the person is at expressing himself or herself, and whether the person presents information in a more linear manner or a more nonlinear manner; based on the communication profile of the person, generating a recommendation concerning communication by the person in a particular communication environment; and communicating the recommendation for consideration ; and

U.S. Patent Publication No,: 2002/0045154, which teaches a method and system for determining personal characteristics of an individual or group and using same to provide personalized advice or services. The system dynamically incorporates several personality dimensions, life style, quality of life, cultural context, demographics, and psychographics, as requested by the test administrator or individual user, and controls and standardizes the testing protocol, and retains test data in such a way that individuals and non-professional users can reliably self administer the tests, save their test results in a system database, and use the results to obtain personality-based advice, content, and people-matching services from a system proprietor.

The inventions heretofore known suffer from a number of disadvantages, including but not limited to being ineffective, being difficult for bidders to understand, being slow, not speeding up bidding, not optimizing bidding prices, failing to engage bidders, failing to engage more potential bidders, being difficult to use, not being exciting for bidders, failing to leave bidders with a memorable experience, not catering to individual bidders, failing to generate sufficient funds for charities, not being efficient, not providing analytics, not providing anonymity among bidders, not providing a unique bidding experience, not being scalable and customizable at the same time, failing to broaden the bidder base of an event, failing to match prospective bidders to events, and failing to increase the pleasure of an auction for its participants.

What is needed is an auction management system and/or method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available auction methods and systems. Accordingly, the present invention has been developed to provide a computerized auction method and system.

In one non-limiting embodiment, there is a method of operating an auction over a computerized network. The method may include one or more of the steps of: requesting personality data from a bidder through a user interface; analyzing received personality data, using a processor, from the bidder to determine a personality type from a set of personality types; associating the determined personality type to a bidder account within a computerized auction system that is assigned to the bidder; providing a computerized library of notification messages that include a multiplicity of notification messages for auctions that each include information presented according to a communication style that is crafted to promote taking action by a particular personality type and associated within the computerized library with that particular personality type; automatically generating a notification for the bidder based on an event that occurs within the computerized auction system; automatically generating a custom notification message for the bidder from the computerized library of notification messages based on the notification in combination with the determined personality type of the bidder; and/or presenting the custom notification message to the bidder over a user interface.

Such a method may also include one or more of the steps of: receiving a first bid notification for an auction item from the bidder over a computerized network; posting the bid notification to the auction item within the computerized auction system and updating a bid amount; receiving a second bid notification from another bidder that outbids the bid amount; posting the second bid notification to the auction item within the computerized auction system and updating the bid amount; wherein the selected notification message is a message that notifies the bidder that they have been outbid on the auction item; matching bidders of similar personality types together and providing communication over the computerized network between them during an auction.

It may be that on the event of a bidder being outbid or losing a bid for an auction item, the computerized auction system automatically sends a request to the bidder to allow their bid amount to go to a charity. It may be that the computerized library of notification messages includes notification messages that notify a bidder that they have been outbid and are crafted to promote taking the action of placing another bid that is higher than a current bid. It may be that the notification includes the bidder as a notification recipient and includes: notification data, a notification type, and identifies the bidder as a notification recipient. It may be that the step of automatically generating a custom notification message for the bidder further includes selecting a notification message from the computerized based on a query of notification type in combination with the determined personality type of the bidder and automatically combining notification data into the selected notification message. It may be that the event is the bidder being outbid on the auction item. It may be that the custom notification message includes computer readable instructions for changing a format of a user interface.

In another non-limiting embodiment of the invention, there is a method of operating an auction over a computerized network that may include one or more of the steps of: requesting personality data from a bidder through a user interface; analyzing received personality data, using a processor, from the bidder to determine a personality type from a set of personality types; associating the determined personality type to a bidder account within a computerized auction system that is assigned to the bidder; providing a computerized library of notification messages that include a multiplicity of notification messages for auctions that each include information presented according to a communication style, including message presentation formatting, that is crafted to promote taking action by a particular personality type and associated within the computerized library with that particular personality type; automatically generating a notification for the bidder based on an event that occurs within the computerized auction system, wherein the notification includes the bidder as a notification recipient and includes: notification data, a notification type, and identifies the bidder as a notification recipient; automatically generating a custom notification message for the bidder from the computerized library of notification messages based on the notification in combination with the determined personality type of the bidder by selecting a notification message from the computerized library based on a query of notification type in combination with the determined personality type of the bidder and automatically combining notification data into the selected notification message; presenting the custom notification message to the bidder over a user interface; receiving a first bid notification for an auction item from the bidder over a computerized network; posting the bid notification to the auction item within the computerized auction system and updating a bid amount; receiving a second bid notification from another bidder that outbids the bid amount; posting the second bid notification to the auction item within the computerized auction system and updating the bid amount.

It may be that the selected notification message is a message that notifies the bidder that they have been outbid on the auction item. It may be that the computerized library of notification messages includes notification messages that notify a bidder that they have been outbid and are crafted to promote taking the action of placing another bid that is higher than a current bid. It may be that the custom notification message includes computer readable instructions for changing a format of a user interface.

In still another non-limiting embodiment of the invention, there is an auction management system operating over a computerized network that may include one or more of a computerized library of notification messages that include a multiplicity of notification messages for auctions that each include information presented according to a communication style that is crafted to promote taking action by a particular personality type and associated within the computerized library with that particular personality type; a chat tool that permits bidders to chat with each other; a personality assessment tool that automatically queries the plurality of bidders for personality type information over the computerized network, analyzes bidder responses, and determines personality types based on the responses; and/or a computerized auction system functionally coupled to the computerized library and to the personality assessment tool that: manages a bidder account for each bidder, records the determined personality types in association with their respective bidder accounts, and/or performs an auction over the computerized network by communicating customized notification messages related to the auction to the plurality of bidders.

It may be that the customized notification messages are generated automatically by the computerized auction system based on a return from the computerized library based on notification type in combination with the determined personality type of the bidder to receive the customized notification message. It may be that the customized notification messages notify bidders that they have been outbid and are selected to increase the probability that a bidder increases their bid. It may be that the personality types are selected from the group of personality types consisting of those presented by the DISC and Hermann Brain Dominance models. It may be that the personality assessment tool determines if a bidder is responsive to competitive statements and if so the computerized auction system automatically generates customized notification messages that include competitive statements therein. It may be that the computerized auction system automatically aggregates bidder personality type information and provides it to an auction host. It may be that, on the event of a bidder being outbid or losing a bid for an auction item, the computerized auction system automatically sends a request to the bidder to allow their bid amount to go to a charity.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of an auction management system, according to one embodiment of the invention;

FIG. 2 is a module diagram of an adaptive engine module of an auction management system, according to one embodiment of the invention;

FIG. 3 is a module diagram of a third party interactive module of an auction management system, according to one embodiment of the invention;

FIG. 4 is a module diagram of a user interface module of an auction management system, according to one embodiment of the invention;

FIG. 5 is a sequence diagram of operation of an auction management system, according to one embodiment of the invention;

FIG. 6 is a flowchart showing operation of a method of operating an auction according to one embodiment of the invention;

FIG. 7 shows an auction management system, according to one embodiment of the invention;

FIGS. 8-13 show prophetic screenshots of various notification messages displayed on a user device of a bidder, according to various embodiments of the invention;

FIG. 14 shows a data structure of a record in a computerized library of customized notification messages for an auction according to one embodiment of then invention; and

FIG. 15 shows a data structure of a record of a notification for an auction according to one embodiment of then invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system of network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques tor data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or e of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially or.”

These features and advantages of the present invention will become more fully apparent from the following description and appended claims, or may be learned by the practice of the invention as set forth hereinafter.

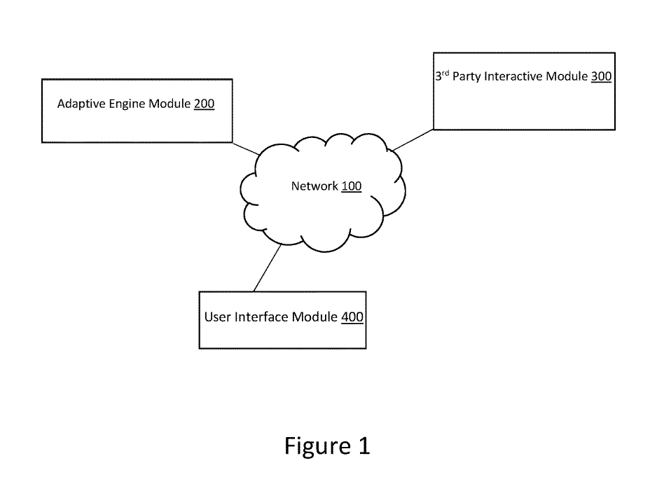

FIG. 1 is a network diagram of an auction management system, according to one embodiment of the invention. There is shown an auction management system including an adaptive engine module 200 in communication with a third party interactive module 300 and a user interface module 400 over a computerized network 100.

The illustrated auction management system is configured to provide an adaptive user interface for users to bid and purchase items in an auction event over a computerized network. The auction management system includes an adaptive engine module configured to collect user data from a plurality of questions. The adaptive engine module is configured to analyze the user data and designate a method of communication for a particular user. The method of communication is specific for each type of personality, based on the answers from the questions from the user. The adaptive engine module is configured to provide language, settings, parameters, preferences, displays, configurations, designs, etc. for a user interface module to provide the best form of communication thereto to a user. The user interface module is configured to communicate with a third party interactive module, wherein the user interacts with the third party interactive module through the user interface module in an auction event to buy, sell, and bid on items over a computerized network.

The auction management system includes a third party interactive module in communication with the adaptive engine module over a computerized network. The third party interactive module is configured to provide an auction module (also called herein an auction system) to a plurality of user interface modules over a computerized network. The auction module is configured to manage an auction event, wherein users, through the user interface module, sell, bid, and buy items over a computerized network. The third party interactive module includes a verification module configured to verify users and items participating in the auction event over a computerized network.

The auction management system includes a plurality user interface modules in communication with the adaptive engine module and the third party interactive module over a computerized network. The user interface modules are configured to provide users with an adaptive user interface to interact with the third party interactive module, wherein the third party interactive module provides an auction event for users to participate in, over a computerized network. The user interface modules are configured to enable a user to sell, bid, and buy items in the auction event over a computerized network.

According to one embodiment of the invention, there is an adaptive engine module of an auction management system configured to select bidding notification messages based on personality types of the recipient or user of the messages, wherein the recipient or user is prompted to bid, on an item from a third party interactive module, in the language that best communicates to that particular user, through a user interface module provided by the adaptive engine module.

The adaptive engine module is configured to modify the looks and feel of a user interface module and/or other interfaces that the user may use over a computerized network. The adaptive engine module includes a personality module configured to obtain data from a user and analyze the data to determine what kind of personality type the user is. The adaptive engine module includes a user account module configured to store data about each individual user. The adaptive engine module may be configured to integrate with social media accounts of the user. The adaptive engine module is in communication with a third party interactive module, wherein the third party interactive module is configured to host an auction event, wherein the adaptive engine module is configured to correspond with users based upon the personalities of each user that are participating in the auction event to buy, sell, and bid on items. Users (bidders and hosts) may also be notified of other events, similar items up for auction that may be at other events, and the like by a third party interactive module based on their profile. There may be a search tool to allow a user to search current and/or upcoming events for particular items and/or keywords associated with such items and alerts may be sent to the user if such items are present at future events (i.e. automated and/or recursive searching with automatic notification). The auction management system is configured to enable users to participate in auction events that are remote from the user.

In one non-limiting embodiment, there is a recommendation engine/module of an auction management system that automatically selects bidding notification messages based on stored personality types of the recipient of the messages so that people are prompted to participate in a bidding/auction setting in the language and/or language-style that best communicates to them. The recommendation engine may change the look and/or feel of the application, its layout, format, language, scripting, timing and/or other interfaces and/or content that the user may experience and/or interact with. There may be a module that obtains information from the user according to a scripted and/or intelligently automated system and then automatically analyzes the results to determine what kind of personality type to store in regards to the associated account. There may be an account system at stores information about particular bidders/users and may integrate with social media accounts they have. The host of the auction event may be served aggregate information about the personalities of those that participated in the event and such aggregate information may be automatically aggregated and/or analyzed by one or more modules and/or reported automatically using one or more modules. Users (bidders and hosts) may also be notified of other events that they might be interested in and such notifications, the content thereof, the formatting thereof, and/or the selection particular events may be based on their profile and/or their stored personality type. Because this is done over a network, people can participate in auctions that are remote from them, anywhere in the world.

In another non-limiting embodiment, there is a user interface system that modifies itself and/or its interactions with others based on an observed personality type of the recipient of messages from the system. Various personality scoring and/or categorization methods may be used alone and/or in conjunction with each other, including but not limited to DISC profiles, Hermann Brain Dominance analysis, various personality color coding systems, and the like and combinations thereof. Users may self-select their profiles/categorization/score instead of being assigned such through analysis/questions. The system may be self-learning automatically in that variations from the suggested/scripted content/material may be provided to test the accuracy of the stored personality type/score/etc. and such variances and how the user responds to those variances may be used to alter stored personality information from the user. Such self-learning may be how the initial personality information is generated, such that the user it not even aware that their personality is being probed to begin with. Responses may be measured according to time delay from message to response, with shorter responses indicating greater engagement with the user, thereby more heavily weighting the style of content that generated the quicker responses.

In still another embodiment, there is an auction management system that includes an automatically self-modifying user interface modules as described herein. There may be a great variety of types of auctions that may be so served, including but not limited to auctions that are dual bid, sealed bid, Dutch, English, combination, multi-part, reverse, penny, and the like and combinations thereof.

In still yet another embodiment, there is an auction management system that tracks personality profiles of users, including but not limited to auction hosts, auction presenters, auction participants, and the like and combinations thereof. Groups may be tracked by personality profiles across the group and “average” or predominant personalities may be stored in association with the group and content/formatting/messaging/etc. may be adapted to the stored personality of the group, especially wherein broadcast messages (billboards, indoor signs, announcements, etc.) are used that may be not targeted to specific people.

In still yet another additional embodiment, there is an auction management system that pushes customized content to one or more associated mobile devices or remote devices such as but not limited to cellphones, smartphones, smart televisions, tablets, personal computers, gaming consoles, kiosks, and the like and combinations thereof.

Other options/features that may be included are:
providing cyclical bid messages (selecting messages based on personality type by selecting and/or cycling through a library of messages adapted to a specific personality type—tracking success rates of specific messages and weighting message delivery according to success),
pushing ½ bid requests to users (a system automatically sending a bid request to auction participants that are higher than the recent highest bid but lower than the automated incremental next bid and this could be automated in response to a high bid persisting for a specific length of time),
automatically pushing requests to people who lose bids asking that they change their losing bid to a donation (system automatically giving option to people who have been outbid to let their bid, or a portion thereof, stay in place to donate to the charity and just not win the item),
including a buy-it-now option within the user interface provided to bidders that is based on high-bid escalation details (as the high bid moves up, based on the value of the item, the buy-it-now button has an automatic value that starts at a percent of the retail value of the item but as the high bid increases the buy-it-now button also automatically scales up, such as but not limited to as a percentage of the high bid, for example it may be the higher of 125% of the value of the item or 125% of the highest hid),
automatically suggesting to users of the system that they get involved with other charities/events that match their personality/history/profile/etc. (system automatically matches auction participants (personality type, participation history, purchase history, etc.) with charities/events as they are set-up in the system and/or based on other triggers, as matches occur a push-notification is automatically sent to the auction participants with automated buttons/links/etc. to allow them to participate/subscribe/etc.),
system keeps a history of all transactions, processes them according to the tax rules and at the end of the year the system sends out a notification to each participant that includes their total donation details along with sufficient information to allow them to file their taxes,
system automatically sends an alert of an auction closing, nearing close, timing out, starting, changing or otherwise experiencing a notable event, these alerts may be configurable on the user level with automated scripts based on settings in the user profile,
chat feature between auction participants including a chat blocking feature that may be enabled by auction participants, event organizers, and etc.,
event administration features that allow the event administrator to view ongoing event statistics (participants, bids, bid values, bid value totals, completed auctions, incomplete auctions, etc.),
pushing a picture of the winning bidder (or avatar) to participants,
participant grouping features that allow for shared bids to occur and for shared bid invitations to be sent to the system (can invite other people to share in the cost for you to bid on an item, system ends an invitation to a group of people who may be a family/friends/co-workers/etc. and asks if they are willing to contribute a specific $ amount each or a total as a group for the item/service/etc. which is being auctioned),
system can feature an item throughout the system,
system provides automated shipping options/information,
automated taunting feature, wherein system automatically (and/or on trigger by the auction participants) sends a taunting message (image, text, video, etc.) to another user who you just outbid and the taunting message may be selected from a predefined library and/or others may be able to add to the library,
system automatically integrates into a social media platform (Facebook, LinkedIn, Twitter, etc.) to announce/invite events, auctions, bids, wins, etc.,
system automatically collaborates with large advertisers by allowing them to pay for an ad to be hosted on the app along with a fund set up by the large advertiser which automatically allows the charities that meet the characteristics set up by the advertiser in the system to select that as an advertisement and then receive a share of money in the fund based on factors having to do with their event characteristics, attendance, participation of other charities, and etc., and/or
having user accounts for bidders that keep track of bidding history, event participation, and other account characteristics and information available to the system and that provides virtual awards that may be triggered based on particular achievements, such as but not limited to getting a Philantropist award at $5000 donated to charities. Such awards may be automatically associated with account changes, permission/rights changes within the system, new/additional names/titles/statuses, and the like and combinations thereof.

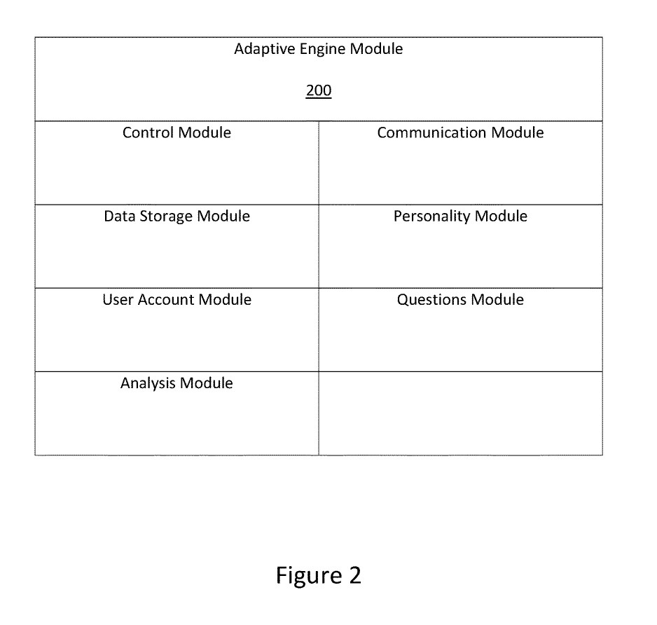

FIG. 2 is a module diagram of an adaptive engine module of an auction management system, according to one embodiment of the invention. There is shown an adaptive engine module including a control module, a communication module, a data storage module, a personality module, a user account module, a questions module, and an analysis module.

The illustrated adaptive engine module is configured to collect and analyze user data and designate a method of communication for a particular user. The method of communication is based on the personality of the user, such as but not limited to: aggressive, competitive, friendly, quiet, neutral, passive, passive aggressive, etc. The method of communication is specific for each type of personality and is based on the answers from the questions from the user. The adaptive engine module is configured to provide language, settings, parameters, preferences, displays, configurations, designs, etc. for a user interface module to provide the best form of communication to a user.

The illustrated adaptive engine module includes a control module configured to provide operational instructions and commands to the modules and components of the adaptive engine module. The control module is in communication with the modules and components of an auction management system over a computerized network. The control module is configured to provide managerial instructions and commands to the modules and components of the adaptive engine module. The source of such instructions/commands may be from one or more other modules described herein and/or through interactions between one or more other modules described herein. The control module is configured to set parameters and settings for each module and component of the adaptive engine module. Non-limiting examples of a control module may be a control module described in U.S. Pat. No. 5,430,836, issued to Wolf et al.; or a control module described in U.S. Pat. No. 6,243,635, issued to Swan et al. which are incorporated for their supporting teachings herein. A control module may include but is not limited to a processor, a state machine, a script, a decision tree, and the like.

The illustrated adaptive engine module includes a communication module, such as a network card, system bus, or wireless communication module, and is configured to communicate with a computerized network. The communication module is configured to provide communication capabilities, such as wireless communication, to the modules and components of the adaptive engine module and the components and other modules described herein. The communication module is configured to provide communication between a wireless device, such as a mobile phone, and a computerized network and/or to facilitate communication between a mobile device and other modules described herein. Non-limiting examples of a wireless communication module may be hut not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated adaptive engine module includes a data storage module in communication with the modules and components of the adaptive engine module. The data storage module is configured to collect and store data from each of the modules of the adaptive engine module. The data storage module is in communication with the various modules and components of the auction management system and is configured to store data transferred there through and there between. The data storage module is configured to store data transferred through each of the modules of the adaptive engine module, thereby updating the auction management system and the adaptive engine module with up to date data and real time user and auction data. The data storage module is configured to securely store user data along with data transferred through the adaptive engine module. Data storage modules may be databases and/or data files and the memory storage device may be, but is not limited to, hard drives, flash memory, optical discs, RAM, ROM, and/or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated adaptive engine module includes an user account module configured to provide management and administration capabilities to the adaptive engine module for user account data. The user account module is configured to manage a plurality of accounts and the characteristics associated therewith, wherein the adaptive engine module is configured to provide operational instructions and management capabilities to the user accounts associated with a plurality of users associated with the adaptive engine module over a computerized network. Non-limiting examples of an user account module may be an account management module as described in U.S. Patent Publication No.: 2003/0014509; or a management module as described in U.S. Pat. No. 8,265,650, which are incorporated for their supporting teachings herein.

The illustrated adaptive engine module includes a questions module in communication with the modules and components of the adaptive engine module. The questions module is configured to ask, a user, a specific set of questions to determine the type of personality of the user, and thereby the best type of communication that relates and corresponds to the user over a computerized network. The questions module may be configured to provide a set of questions in a pre-determined order to determine the type of personality that matched the user. Non-limiting examples of a questions module may be a system as described in U.S. Patent Publication 2008/0294637; or a questionnaire software module as described in U.S. Patent Publication No.: 2006/0143023, which are incorporated for their supporting teachings herein.

The illustrated adaptive engine module includes an analysis module in communication with the modules and components of the adaptive engine module. The analysis module is configured to analyze user data from the questions module to determine which type of personality best matches the user, based on the user's answers from the questions from the questions module. Non-limiting examples of analysis module may be a data analysis system as described in U.S. Patent Publication No.: 2012/0290576; or an analysis system as described in U.S. Patent Publication No.: 2011/0208519, which are incorporated for their supporting teachings herein.

The illustrated adaptive engine module includes a personality module in communication with the modules and components of the adaptive engine module. The personality module is configured to match a personality of a user from the data analyzed from the analysis module and generate a specific form of communication for that particular user. The personality module is configured to initiate and provide a user interface module for a particular user over a computerized network. Non-limiting examples of a personality module may be a personality module as described in U.S. Patent Publication No.: 2002/0069002; or a system as described in U.S. Patent Publication No.: 2011/0250575, which are incorporated for their supporting teachings herein.

The adaptive engine module may draw from one or more of the following (and/or other similar) personality typing systems for scripting, questions, communication styles, analysis styles/protocols, and the like and combinations thereof in probing, analyzing, determining, storing, generating and customizing interactions with users of the system. This material is quoted from US Patent Publication No. 20020045154, which is incorporated herein for its supporting teachings:

The work of noted Swiss psychologist Carl Jung in the 1920's and '30s led him to gather that there were four functions of the mind, two pairs opposing each other, which he labeled “Thinking” versus “Feeling” and “Sensation” versus “Intuition.” He believed that although all people possess these abilities, one of the four functions dominates a person's personality. Based on the mental functions and attitudes that Jung described, in the 1950's psychologists Isabel Myers and Katherine Briggs developed a personality test, the now widely used Myers-Briggs Type indicator (MBTI), The MBTI rates people's written responses to questions to measure four sets of opposing characteristics. Each set is a continuum with opposite ends designated by letters which denote the pair's behavioral extremes:

Extroversion E . . . I Introversion

Sensation S . . . N INtuition

Thinking T . . . E Feeling

Judging J . . . P Perceiving

Testing identifies a person's gravitation toward one end or the other of each set of characteristics, and by the combination of which sixteen types of personalities that are possible (for example, ESTJ, ISTJ, etc.

In the 1970's and '80s, Ned Herrmann conceived of different modes of thought occurring in various regions of the brain, in the higher level cortex and lower level limbic system. His Whole Brain Model comprised four quadrants of thinking styles linked to particular regions of the brain, with processes occurring on the left or right.

A-quadrant
Analytical, quantitative logical, fact-based

D-quadrant
Intuitive, holistic, integrating, synthesizing

B-quadrant
Organized, sequential planned, detailed kinesthetic

C-quadrant
Interpersonal, felling-based emotional

In Herrmann's model, the four clusters of processing are typically available in each person, but one or more of the clusters is naturally dominant in a person's temperament, similar to Jung's theory. Through two decades of testing and applying his model to organizations, Herrmann amassed findings which indicate that the population is evenly distributed among these four types of thinking specialties. That is, 25% of the people show dominance in A-type analytical thinking, another 25% show dominance in B-type organized thinking, and so on around all four quadrants. This data suggests that groups and societies operate in such a way that each person's specialties of thought are balanced among the group as a whole. Although people are not all created equal, different styles of thinking appear to serve equally weighed roles in balancing each other to optimally achieve the group's common purposes. This generally fits with data in the 1970's by psychologists David Keirsey and MarilynBates. Their studies of married couples with Myers-Briggs testing showed an equal distribution among particular personality types: 25% were TJ's (favoring Thinking with Judging), 25% were FJ's (Feeling with Judging), 25% FP's (Feeling with Perceiving), and 25% TP's (Thinking with Perceiving). These Myers-Briggs types roughly equate to sides of the square Herrmann model (Herrman's AB side being TJ's, BC side FJ's, and so on). This data corroborates the understanding of thinking styles as a system in which each combination of thinking processes is offset and balanced by its corresponding opposite among the population as a whole.

In the 1980's Katherine Benziger modified Herrmann's model with new theories by neurosurgeon Karl Pribram, Pribram suspected that the four different modes of thought were all processed in the uppermost cerebral cortex of the brain, but in its different quadrants of the left and right hemispheres' frontal and basal lobes. Although the locations of the processing were different from Herrmann's, her four-way model of modes of thought was similar:

Front Left quadrant
Analyzing, evaluating. Making goals and decisions

Front Right quadrant
Imagining conceptualizing, generating holistic images

Basal Left quadrant
Sequencing, planning Details, carrying out orderly routines

Basal Right quadrant
Harmonizing, synthesizing, associating expression and meaning

Before returning to the development of the present invention, it is noted that in addition to those models already mentioned, there are now many other four-way models of temperament and personality in common use by psychologists and human development specialists.

There are other such systems which categorize temperament, personality, or behavior into four categories that are identified by letters, words, and/or animal icons. Virtually all of these systems use individual written testing and scoring to determine one's personal style.

Other related methods and devices for typing personalities exist, yet none possess the unique characteristics of the present invention.

Virtual (Psychological) Modeling

Temperament is a predisposition to act via certain predictable behavior patterns. Personality temperament has been extensively studied and certain temperaments shown to be identifiable for a several thousand years. By asking a set of questions, a temperament can be assessed. The Keirsey Temperament Sorter is an example of a set of questions that when aggregated into a “temperament” can help predict an individual's behavior patterns [Please Understand Me II, by David Keirsey] The Keirsey Temperament Sorter asks 70 questions and aggregates the responses into four basic temperaments, each with four variants, to create 16 temperament variants. When a person answers these 70 questions, a great deal of the behavior patterns of the individual can be inferred from the assessed temperament

Temperament as a Financial Indicator

The notion of temperament regarding an individual's financial behavior (specific attitudes regarding planning, saving and investing, wealth and family protection, as well as making financial decisions under conditions of risk and uncertainty) has been studied and clear patterns of a set of temperament profiles have been devised. However, financial behavior for each individual is complex and depends, not only on temperament, but also on a host of other factors such as life style, cultural context, and financial knowledge and experience in investing. Models of personality, financial temperament and human behavior can improve the client's satisfaction by considering the appropriate influence points of the client and the selection of appropriate financial content, services, products and advice, which will be delivered, primarily on the Internet to end users or as a tool used by financial professionals and their organizations to enable them to better “know” and to better service their customers.

To better help the individual in a financial process, such as investing, a thorough knowledge of the individual's psychological profile, financial situation, and experience is crucial. In the past, this has been the role of a human financial advisor (“Advisor/broker”). Soliciting information about individuals in an incremental way on the web, constant analysis of financial behavior, and adjusting of psychological models, will further improve the prediction of behavior and ultimately help the individual learn quicker and make better financial decisions, customized to his style and circumstance.

It is believed that when studying human behavior or measuring people's reactions to situations, we find patterns that allow us to group people by their similarities. The method for doing this has traditionally been personality testing, and many theories and instruments have been developed over the years to help explain the similarities and differences in people. One such test is the Keirsey Temperament Sorter. Developed in 1978 by David West Keirsey, the sorter categorizes people into 4 main Temperaments each with 4 variants for a total of 16 personality types, Dr. Keirsey's work is based upon the works of Carl Jung, who wrote about 8 main personality types. It is also based on the work of Isabel Myers, who developed the Myers Briggs Type Indicator (MBTI), a similar instrument that categorizes people into essentially the same 16 personality types.

The primary uses of the 16-type model have been in the corporate setting, individual career counseling, and psychotherapy. Many companies try to improve communication between employees and offer workshops and seminars to foster better understanding and communication among employees. If each employee can understand the values and motivations behind his/her own personality type and then understand those of the other types, then personality-based conflicts can be recognized, understood, and better managed. This leads to a healthier work environment and higher productivity. Traditionally, personality testing requires the oversight and interpretation of a trained psychologist. This training or certification is done to ensure quality control and standardization in the interpretation of results and management of emerging psychological and ethical issues.

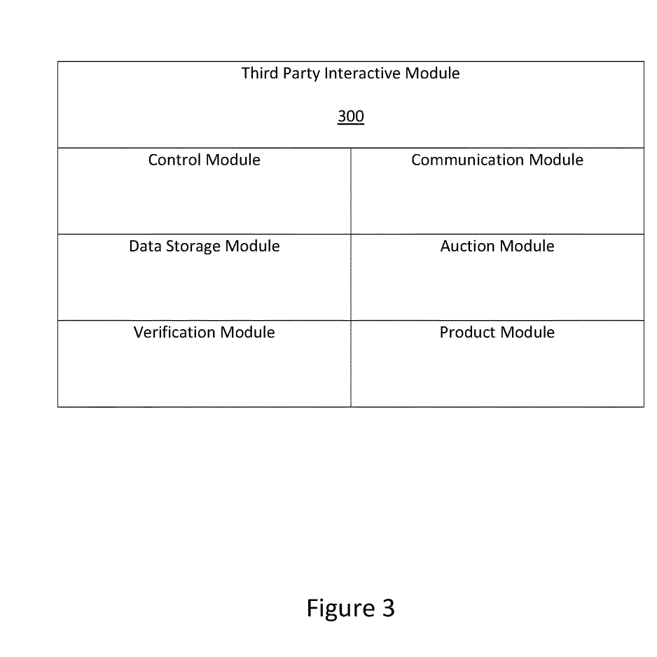

FIG. 3 is a module diagram of a third party interactive module of an auction management system, according to one embodiment of the invention. There is shown a third party interactive module including a control module, a communication module, a data storage module, an auction module, a product module, and a verification module.

The illustrated third party interactive module is in communication with the adaptive engine module over a computerized network. The third party interactive module is configured to provide an auction module to a plurality of user interface modules over a computerized network. The third party interactive module is configured to manage an auction event, wherein users, through the user interface module, sell, hid, and buy items over a computerized network. The third party interactive module is configured to verify users and items participating in the auction event over a computerized network.

The illustrated third party interactive module includes a control module configured to provide operational instructions and commands to the modules and components of the third party interactive module. The control module is in communication with the modules and components of an auction management system over a computerized network. The control module is configured to provide managerial instructions and commands to the modules and components of the third party interactive module. The source of such instructions/commands may be from one or more other modules described herein and/or through interactions between one or more other modules described herein. The control module is configured to set parameters and settings for each module and component of the third party interactive module.

The illustrated third party interactive module includes a communication module, such as a network card, system bus, or wireless communication module, and is configured to communicate with a computerized network. The communication module is configured to provide communication capabilities, such as wireless communication, to the modules and components of the third party interactive module and the components and other modules described herein. The communication module is configured to provide communication between a wireless device, such as a mobile phone, and a computerized network and/or to facilitate communication between a mobile device and other modules described herein.

The illustrated third party interactive module includes a data storage module in communication with the modules and components of the third party interactive module. The data storage module is configured to collect and store data from each of the modules of the third party interactive module. The data storage module is in communication with the various modules and components of the auction management system and is configured to store data transferred there through and there between. The data storage module is configured to store data transferred through each of the modules of the third party interactive module, thereby updating the auction management system and the third party interactive module with up to date data and real time user and auction data. The data storage module is configured to securely store third party and user data along with data transferred through the third party interactive module.

The illustrated third party interactive module includes an auction module configured to manage and provide an auction event over a computerized network. The auction module is in communication with a plurality of user interface modules of an auction management system over a computerized network. The auction module is configured to manage and conduct an auction event, wherein users, through the user interface modules, buy, bid, and sell items over a computerized network. Non-limiting examples of an auction module may be an auction module as described in WO2010134766; or a system as described in U.S. Patent Publication No.: 2013/0080330, which are incorporated for their supporting teachings herein.

The illustrated third party interactive module includes a verification module configured to verify users and user interface modules; along with products available in the auction event. The verification module is configured to verify user data associated with the user interface module of the auction management system. The verification module is configured to verify items available in the auction event. Non-limiting examples of a verification module may be a verification module as described in U.S. Pat. No. 6,853,973, issued to Mathews et al.; or a computer program as described in U.S. Pat. No. 7,051,343, issued to Bracha et al., which are incorporated for their supporting teachings herein.

The illustrated third party interactive module includes a product module configured to provide data to users, through a user interface module, regarding the product or service available in an auction event by an auction module of the auction management system. The product module is configured to enable a user to search for products and services available in the auction event. The product module is configured to store and update product and inventory data to provide real time data regarding products and services available in the auction event. Non-limiting examples of a product module may be a product search engine as described in U.S. Pat. No. 8,374,907; or a product search module as described in U.S. Patent Publication No.: 2012/0290374, which are incorporated for their supporting teachings herein.

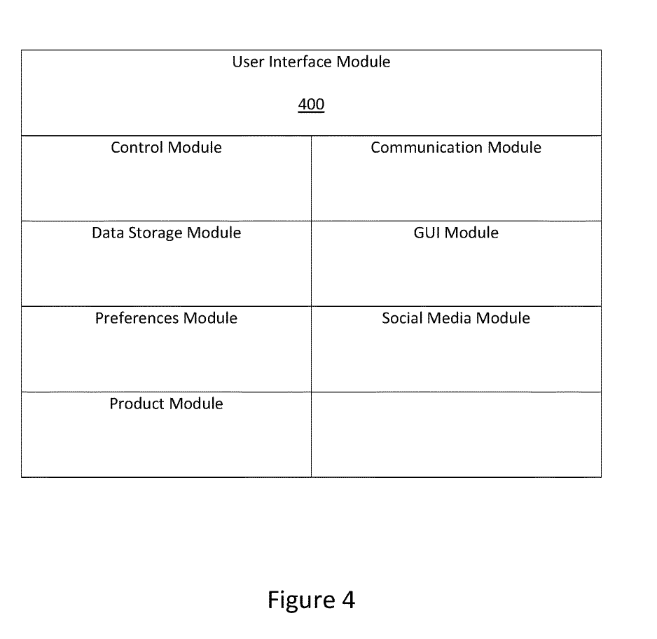

FIG. 4 is a module diagram of a user interface module of an auction management system, according to one embodiment of the invention. There is shown a user interface module including a control module, a communication module, a data storage module, an adaptive graphical user interface module, a preferences module, a social media module, and a product module.

The illustrated user interface module in communication adaptive engine module and the third party interactive module of an auction management system over a computerized network. The user interface module is configured to provide users with an adaptive user interface to interact with the third party interactive module, wherein the user participates in an auction event, by the third party interactive module, over a computerized network. The user interface module is configured to enable a user to sell, bid, and buy items in the auction event over a computerized network.

The illustrated user interface module includes a control module configured to provide operational instructions and commands to the modules and components of the user interface module. The control module is in communication with the modules and components of an auction management system over a computerized network. The control module is configured to provide managerial instructions and commands to the modules and components of the user interface module. The source of such instructions/commands may be from one or more other modules described herein and/or through interactions between one or more other modules described herein. The control module is configured to set parameters and settings for each module and component of the user interface module.

The illustrated user interface module includes a communication module, such as a network card, system bus, or wireless communication module, and is configured to communicate with a computerized network. The communication module is configured to provide communication capabilities, such as wireless communication, to the modules and components of the user interface module and the components and other modules described herein. The communication module is configured to provide communication between a wireless device, such as a mobile phone, and a computerized network and/or to facilitate communication between a mobile device and other modules described herein.

The illustrated user interface module includes a data storage module in communication with the modules and components of the user interface module. The data storage module is configured to collect and store data from each of the modules of the user interface module. The data storage module is in communication with the various modules and components of the auction management system and is configured to store data transferred there through and there between. The data storage module is configured to store data transferred through each of the modules of the user interface module, thereby updating the auction management system and the user interface module with up to date data and real time user and auction data. The data storage module is configured to securely store user data along with data transferred through the user interface module.

The illustrated user interface module includes an adaptive graphical user interface module, G.U.I. module in communication with the modules and components of the user interface module. The user interface module is configured to provide individual user interface capabilities with the auction management system and the modules and components thereof, over a computerized network. The user interface module is configured to provide a specific method of communication, from an adaptive engine module, to communicate with a third party interactive module over a computerized network. The adaptive engine is configured to provide one or more interfaces for accessing systems over a computerized network. Such may include one or more graphical user interfaces that may be embodied in software instructions for controlling display on a display (such as but not limited to a TV, monitor, cell phone/tablet screen, etc.) and/or for routing signals from an input device (such as but not limited to a keyboard, touchscreen, mouse, etc.) such that a user may perform data entries or queries in the system, issue suggestions or recommendations, and receive data information therefrom. Such may be embodied in one or more user interfaces that permit browsing of the system. Such may be embodied in one or more user interfaces that permit service personnel to make adjustments, changes, and otherwise provide personal profile updates to the system. Such may be embodied in one or more user interfaces that permit review of data from the system, such as but not limited to travel data, vacation data, profile data, other user profile data. Non-limiting examples of interface modules may be a HTML player, client server application, Java script application. A non-limiting example of an interface module is FlowPlayer 3.1, manufactured by FlowPlayer LTD, Hannuntie 8 D, ESPOO 02360, Helsinki, Finland. Non-limiting examples of a display/interface module may be a display/interface module as described in U.S. Pat. No. 6,272,562, issued to Scott et al.; a touch screen interface module as described in U.S. Pat. No. 5,884,202 and U.S. Pat. No. 6,094,609, issued to Arjomand, which are incorporated for their supporting teachings herein.

The illustrated user interface module includes a preference module in communication with the modules and components of the user interface module. The preference is configured to manage and store personal user account preferences while interacting with systems, such as the auction management system, over a computerized network. The preferences module may be configured to store and manage a user's parameters, personal data, financial data, business data, etc. for use with the auction management system, the adaptive engine module, and/or the third party interactive module. Non-limiting examples of a preference module may be a system as described in U.S. Patent Publication No.: 2012/0310701; or a user account module as described in U.S. Patent Publication No.: 2012/0330785, which are incorporated for their supporting teachings herein.

The illustrated user interface module includes a social media module in communication with the modules and components of the user interface module. The social media module is configured to link a user to a social media site. The social media module is configured to provide access to a social media site; wherein the user may post or link data regarding the use of the auction management system. The social media module is configured to enable a user to promote a product or service related to the auction management system through a social media site over a computerized network. Non-limiting examples of a social media module may be Facebook, Twitter, Instagram, LinkedIn, YouTube, and etc. and/or applications thereof. Such may be integrated with a social network system and may provide announcements, feedback, and/or collaborative usage through a network.

The illustrated user interface module includes a product module configured to provide users the ability to sell items in an auction event over a computerized network. The product nodule is configured to enable a user to promote, verify, document, display, etc. a product for sale by the user in the auction event over a computerized network. The product module is configured to store and update product and inventory data to provide real time data regarding products and services, by the user, available in the auction event. Non-limiting examples of a product module may be a system as described in U.S. Patent No.: 8,319,607; or a system as described in U.S. Patent Publication No.: 2007/0011055, which are incorporated for their supporting teachings herein.

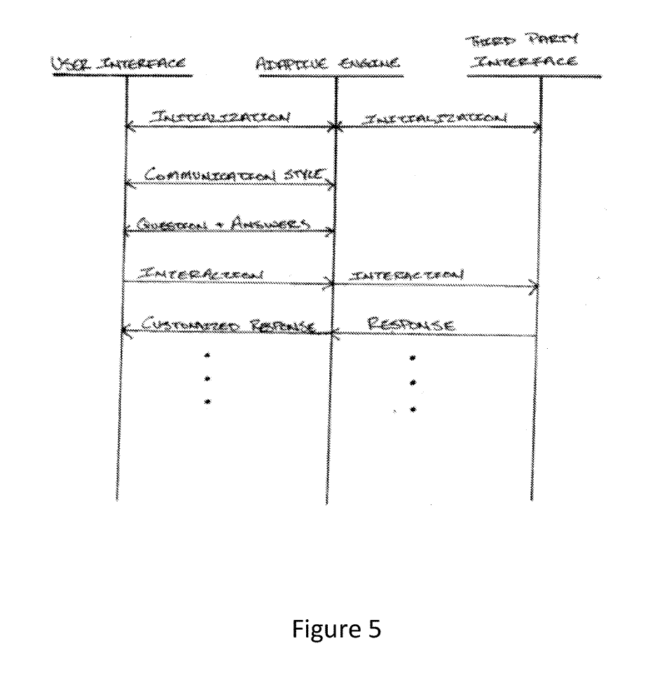

FIG. 5 is a sequence diagram of an auction management system according to one embodiment of the invention. There is shown a user interface in communication with an adaptive engine and a third party interface over a computerized network.

The illustrated sequence diagram includes a user interface in communication with an adaptive engine and a third party interface. The user interface and the third party interface are configured to initialize use from the adaptive engine module. The adaptive engine module is configured to provide a communication style, such as an adaptive graphical user interface module for a user to communicate with the third party interface. The adaptive engine asks questions to the user, through the user interface, the user responds with answers to the questions. The adaptive engine translates the answers to determine a style of communication that best fits the user. The adaptive engine provides settings, parameters, and rules for communicating the user through the user interface.

The user interface is configured to interact with the third party interface through the adaptive engine. The third party interface is configured to respond to interaction from the user interface through the adaptive engine, The adaptive engine is configured to modify the response, to a customized response for that particular user interface.

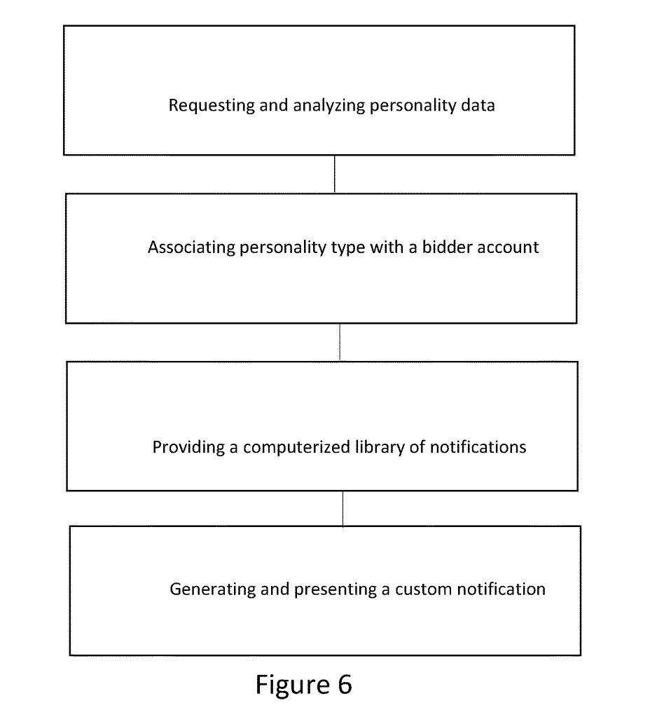

FIG. 6 is a flowchart showing operation of a method of operating an auction according to one embodiment of the invention. Any of the tools/functions/modules described in this specification may be utilized as appropriate to execute the steps described herein. There is shown a step of requesting and analyzing personality data, followed by a step of associating personality type with a bidder account, Wowed by a step of providing a computerized library of notifications followed by a step of generating and presenting a custom notification. The illustrated method provides for a more engaging auction experience for the bidders and increases the likelihood of a successful auction.

The illustrated step of requesting and analyzing personality data includes requesting personality data from a bidder through a user interface. It also includes analyzing received personality data, using a processor, from the bidder to determine a personality type from a set of personality types. The request may take the form of sending a questionnaire over the network to a user interface operated by the bidder and receiving the responses from the same. The following are non-limiting examples of questions that might be asked:

Forced Choice Example:

Rank the following words from most likely to describe you to least like describe you:

Enthusiastic, daring, diplomatic, satisfied

Survey-style Example:

I can be pretty forceful with my opinions.

Strongly disagree-Disagree-Neutral-Agree-Strongly Agree

Multiple-Choice Example:

I prefer to learn:

a. details and specific facts

b. from a general overview of things

c. both ways about equally

An auction system may provide a plurality of questions to a bidder, receive and/or record the answers to the same and then analyze the answers according to an analysis protocol to make a determination about a personality type of the bidder. Analysis protocols and/or analysis thereof may be obtained through Hermann International Inc., PO BOX 389, Forest City, N.C. 28043 and through Your Life's Path, 538 1^{st} Ave. North, Saint Petersburg, Fla. 33701.

Analysis may result in something as simple as a single word or identifier used by the system to identify one of several personality types or may be more complicated, such as but not limited to identifying numerical ranges of prevalence of various personality traits, an ordering of personality characteristics, and the like and combinations thereof. Generally, the results of the analysis will tie to a schema of how custom messages are stored in a computerized library, such that the results of the analysis may be used to query the library.

The illustrated step of associating the determined personality type to a bidder account within a computerized auction system that is assigned to the bidder may be performed by recording a data field in a record associated with the bidder, such as but not limited to in an account held by the bidder in the system. Generally, the stored data will be in a form that is usable by the auction system in coordination with the library. As a non-limiting example, if the library stores its records according to personality types A, B, C, and D, the data field for personality type in the record for the bidder account may simply include an A, B, C, or D. More complicated personality types may be stored using structured data.

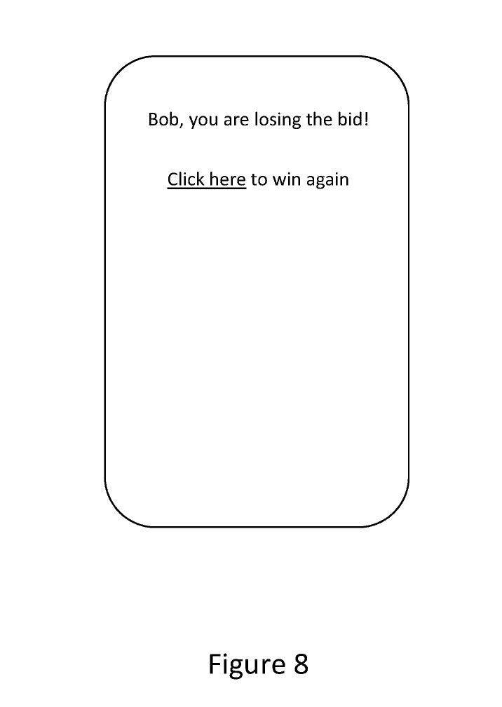

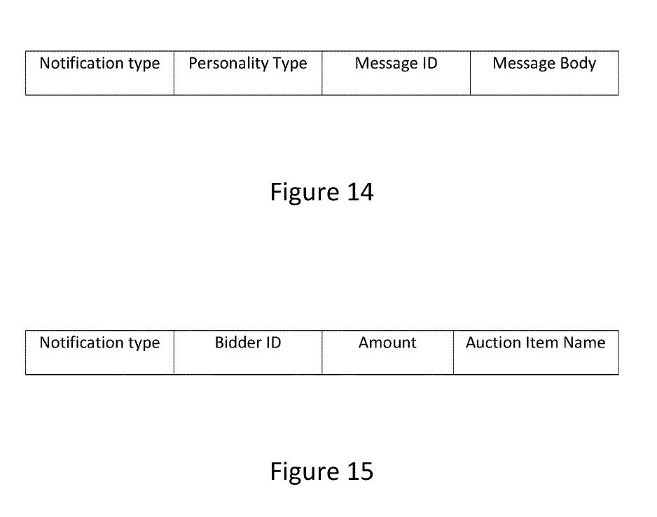

The illustrated step of providing a computerized library of notification messages may be effected by providing access to such a library and/or creating such a library. The library may include a multiplicity of notification messages for auctions that each include information presented according to a communication style that is crafted to promote taking action by a particular personality type and associated within the computerized library with that particular personality type. See FIGS. 8-11 for examples of a single notification type for an “outbid” event being presented according to four different communication styles. See FIG. 14 for a non-limiting exemplary data structure for a computerized library of notification messages.

The illustrated step of generating and presenting a custom notification may be accomplished by automatically generating a notification for the bidder based on an event that occurs within the computerized auction system, then automatically generating a custom notification message for the bidder from the computerized library of notification messages based on the notification in combination with the determined personality type of the bidder and, then, finally presenting the custom notification message to the bidder over a user interface. The auction system, by virtue of hosting/operating the auction will be privy to information related to auction events, such as but not limited to when one bidder outbids another, when an auction for an auction item expires and a winning bid is thereby determined, when a new item is up for auction, etc. The auction system then will automatically trigger a notification to one or more bidders and/or other participants of the auction. The notification will be of a particular type, reflecting the triggering event/status/condition and those notification types can be quantified/characterized within the system. The notification, its type, recipient(s), and other related data may be used to query a computerized library of notification messages to determine an appropriate message template to use in generating a customized notification message for the recipient(s). The template script may then be carried out to auto-fill portions thereof and then executed at the user interface for the recipient, including but not limited to any formatting instructions that may be included with the customized message, including but not limited to displaying images, changing background/foreground coloring, changing border images, text effects (colors, color changes, flashing, message duration, etc.), and the like and combinations thereof.

There may be a step of matching bidders of similar personality types together and providing communication over the computerized network between them during an auction. This may be automated and/or at the request of bidders. It may be triggered by a pair of bidders who have both been high bidders on an auction item having the same personality type and/or having personality types that may benefit from social interaction (e.g. Competitive types or Social Types). This may allow the bidders to enjoy sharing a competitive or social spirit with each other through free or directed communications (e.g. through a chat program or by selecting and submitting preformed messages).

There may also be a step of receiving a first bid notification for an auction item from the bidder over a computerized network. The step may be carried out through a user interface of the bidder (e.g. an auction application installed on their smartphone that is in communication with the auction system), whereby the user selects to place a bid of a particular amount on a particular auction item and submits the bid to the system.

There may also be a step of posting the bid notification auction item within the computerized auction system and updating a bid amount. The auction system may receive an incoming bid notification from a bidder over a computerized network and then record the bid in association with a record of the ongoing auction and update the status of the auction to identify the new bid amount and leading bidder.

There may also be a step of receiving a second bid notification from another bidder that outbids the bid amount. This may be accomplished in the same manner as receiving the first bid, except from a different bidder and thereby, generally speaking, through a different user interface device that will generally have the same or compatible auction application installed.

There may also be a step of posting the second bid notification to the auction item within the computerized auction system and updating the bid amount, which may be accomplished in the same manner as posting the first bid.

It may be that the selected notification message is a message that notifies the bidder that they have been outbid on the auction item FIGS. 8-11).

It may be that on the event of a bidder being outbid or losing a bid for an auction item, the computerized auction system automatically sends a request to the bidder to allow their bid amount to go to a charity.

It may be that the computerized library of notification messages includes notification messages that notify a bidder that they have been outbid and are crafted to promote taking the action of placing another bid that is higher than a current bid.

It may be that the notification includes the bidder as a notification recipient and includes: notification data, a notification type, and identifies the bidder as a notification recipient.

It may be that the step of automatically generating a custom notification message for the bidder further includes selecting a notification message from the computerized library based on a query of notification type in combination with the determined personality type of the bidder and automatically combining notification data into the selected notification message.

It may be that the event is the bidder being outbid on the auction item. It may be that the custom notification message includes computer readable instructions for changing a format of a user interface.

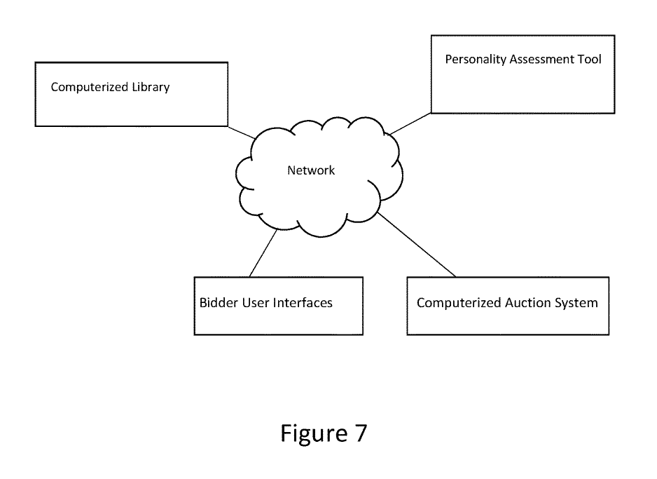

FIG. 7 shows an auction management system, according to one embodiment of the invention. There is shown a network connecting a computerized library, a personality assessment tool (computerized), bidder user interfaces, and a computerized auction system. The system allows for enhanced auctions to occur which have greater success and promote more engagement and enjoyment for the bidders. FIG. 7 is similar to FIG. 1 and essentially shows similar material/structure but focuses on components thereof that are described herewith, while FIG. 1 has a broader focus and includes more components thereof. Any of the tools/functions/modules described in this specification may be utilized as appropriate to support the components described in this figure.

The illustrated computerized of notification messages may include a multiplicity of notification messages stored in a data storage device according to a data storage format/schema for auctions. Each message may include information presented according to a communication style that is crafted to promote taking action by a particular personality type (e.g. of personality types that are tested for using the personality assessment tool) and associated within the computerized library with that particular personality type;

The illustrated personality assessment tool may automatically query a plurality of bidders for personality type information over the computerized network (e.g. on account creation for each bidder and/or on auction initialization). It may analyzes bidder responses and thereby determine personality type(s) based on the responses and an analysis protocol. The tool may include a library of questions/survey tools and the like and may present them to the bidders over their user interface devices. Such delivery may be through an auction application installed thereon. The users may select answers to the questions until the tool has sufficient information to determine a personality type, which it may provide as data to the computerized auction system to be stored in association with a user account of the respective bidder.

The illustrated computerized auction system may be functionally coupled to the computerized library and to the personality assessment tool. The computerized auction system may manage a bidder account for each bidder, record the determined personality types in association with their respective bidder accounts, and/or perform an auction over the computerized network. Such may include communicating customized notification messages related to the auction to the plurality of bidders. Such may also include tracking bids for auction items, tracking auction items, providing tools to allow auction hosts/participants to post auction items within the system, produce marketing/advertising for the auction (e.g. connecting with social media to make announcements), collecting money from bidders, sending money to auction item owners and/or associated charities, and the like and combinations thereof.

There may also be a chat tool that permits bidders to chat with each other. Non-limiting examples of chat programs/tools include: Yahoo! Chat, ICQ, Microsoft NetMeeting, WebEx, MSN chat, Google Chat, Hangouts.

It may be that the customized notification messages are generated automatically by the computerized auction system by the system following/executing a template/script based on a return from the computerized library based on notification type in combination with the determined personality type of the bidder to receive the customized notification message.

It may be that the customized notification messages notify bidders that they have been outbid and are selected to increase the probability that a bidder increases their bid.

It may be that the personality types are selected from the group of personality types consisting of those presented by the DISC and Hermann Brain Dominance models.

It may be that the personality assessment tool determines if a bidder is responsive to competitive statements (e.g. using the words win, lose, loss, victory, champion, loser, etc.; referring to relative status of the bidder with respect to others (e.g. Soandso is beating you), and the like) and if so the computerized auction system automatically generates customized notification messages that include competitive statements therein.

It may be that the computerized auction system automatically aggregates bidder personality type information and provides it to an auction host. This may include statistics on personality types of the group of bidders, bidders that are more active than others, winning bidders, losing bidders, bidders who are not participating/bidding, and the like and combinations thereof. An aution host may use this information in future marketing/advertising and/or to make adjustments to the auction itself in real-time to increase the success and enjoyment of those involved.

It may be that, on the event of a bidder being outbid or losing a bid for an auction item, the computerized auction system automatically sends a request to the bidder to allow their bid amount, or other related or unrelated amounts, to go to one or more charities that may be selectable by the bidder.

FIGS. 8-13 show prophetic screenshots of various notification messages displayed on a user device of a bidder, according to various embodiments of the invention. These prophectic screenshots are illustrated as though they were to appear on a mobile device of a bidder that may have an auction application installed on their device that operates as the user interface for the bidder in communication with an auction system and/or one or more modules/tools described herein. The bidders may download the auction app and install the same on their device(s), log into their account through the auction app and thereby have access to participate in one or more auctions, which may or may not be geographically proximate to the bidders.

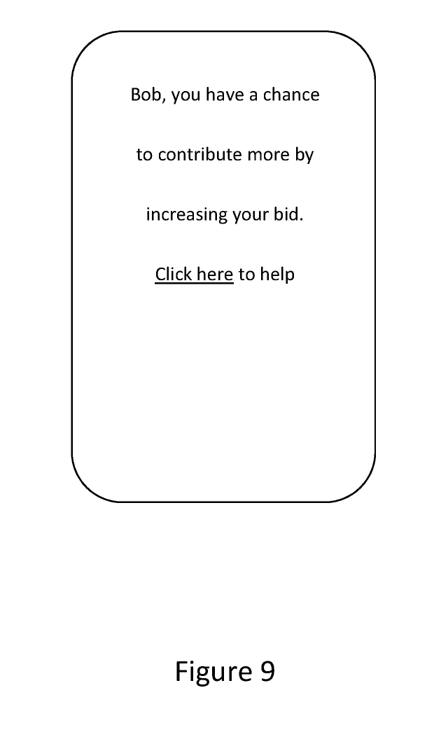

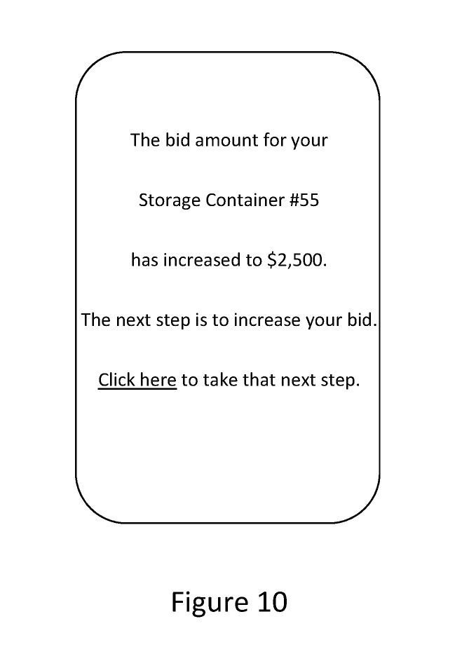

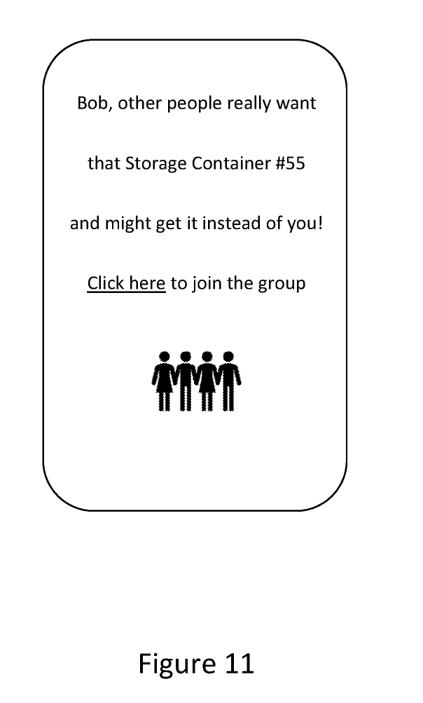

FIGS. 8-11 show a customized notification message for a notification that the bidder has been outbid on an auction item, but customized for four different personality types, which may be described as (not necessarily specific to any particular personality type schema) Competitive (FIG. 8), Contributory (FIG. 9), Procedural (FIG. 10), and Social (FIG. 11). Accordingly, each bidder may be presented with, essentially, the same facts, but in such a manner that is consistent with their perception of the experience and their place in it. Therefore, they are more likely to be engaged in the auction and participate in a manner that is more self-consistent, gratifying, and memorable.

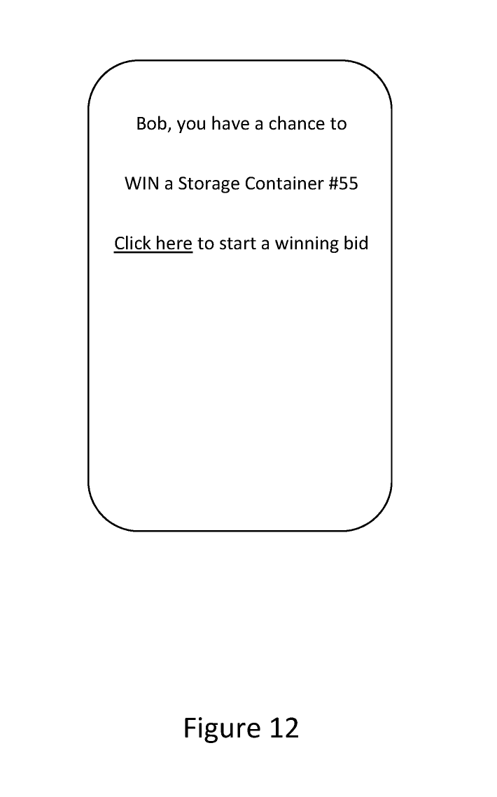

FIG. 12 shows a customized announcement of a new item up for auction. The bidder is called by name and the auction item name is presented for the bidder to see. The auction app may include a menu that allows the bidder to search for the auction item by name and/or lot number and get more information about the same.

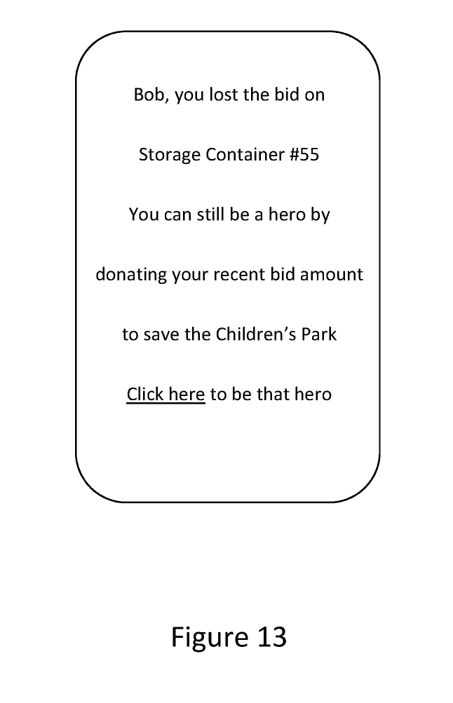

FIG. 13 shows a customized notification sent after a bidder has lost an auction on an auction item, with a request, that, the last bid amount be donated to a charity. The link may lead to a page where the bidder may select to donate 100%, 90%, 80%, etc. or even more than the last bid amount.

FIG. 14 shows a data structure of a record in a computerized library of customized notification messages for an auction according to one embodiment of then invention. The illustrated structure shows a notification type, a personality type, a message id, and a message body. The system may use data from such records to search for and create appropriate customized notification messages based on events and/or notifications generated by or experienced through an auction management system.

The notification type may identify a type of notification, such as but not limited to: new auction item announcement, outbid notification, additional information broadcast about an auction item, announcement of what charity receives proceeds from a winning bid associated with an auction item, announcement of winning bid/bidder, and the like and combinations thereof. The record may identify various notification types by an ID number, name, or other identification schema. Notification types may include rules and/or standards about what data types/structures/elements they include and/or what kind of messaging must accompany the notification, including but not limited to hyperlinks and other operational tools. As a non-limiting example, the new auction announcement notification type might include a name and/or lot number of the auction item to be announced along with a starting bid and/or reserve amount.

The personality type may include one or more identifiers for personality types according to one or more schemas of recognized personality types of bidders. Such may be referenced by type numbers, letters, words, strings, and the like. Personality types may he identified simply, such as types A, B, C, and D and/or in a more complex manner, such as but not limited to types that are primary A, B, C, or D and/or secondary A, B, C, and/or D, and/or thirdly A, B, C, or D, and/or fourthly A, B, C, or D (e.g. BCDA as compared to DBAC). The system may search such records by notification type and by personality type to find a record that matches both and then pull the message body from such a record to be used to craft an appropriate customized notification message.

The Message ID may be used to uniquely identify such records.

The Message Body may include data that facilitates creation of customized notification messages. As non-limiting examples, the following might be message bodies for the messages provided in FIGS. 8-13 (no specific programming language is referenced herein, only prophectic exemplary code of a non-specific language).

FIG. 8: <<BidderName>>, you are losing the bid! <<CR>> <<Hyperlink=www.bidnow/<<AuctionID>>, Click here>> to win again

FIG. 9: <<BidderName>>, you have a chance <<CR>> to contribute more by <<CR>> increasing your bid. <<CR>> <<Hyperlink=www.bidnow/<<AuctionID>>, Click here>> to help

FIG. 10: The bid amount for your <<CR>> <<AuctionItemName>> <<CR>:> has increased to <<Amount>>. <<CR>> The next step is to increase your bid. <<CR>> <<Hyperlink=www.bidnow/<<AuctionID>>, Click here>> to take that next step

FIG. 11: <<BidderName>>, other people really want <<CR>> that <<AuctionItemName>> <<CR>> and might get instead of you! <<CR>> <<Hyperlink=www.bidnow/<<AuctionID>>, Click here>> to join the group <<CR>> <<GroupHoldingHands.jpg>>

FIG. 12: <<BidderName>>, you have a chance to <<CR>> WIN a <<AuctionItemName>> <<CR>> <<Hyperlink=www.bidnow/<<AuctionID>>, Click here>> to start a winning bid

FIG. 13: <<BidderName>>, you lost the bid on <<CR>> <<AuctionItemName>> <<CR>> You can still be a hero by <<CR>> donating your recent bid amount <<CR>> to <<CharityPhrase>> <<CR>> <<Hyperlink=www.bidnow/<<AuctionID>>, Click here>> to be that hero.

FIG. 15 shows a data structure of a record of a notification for an auction according to one embodiment of then invention. The illustrated structure shows a notification type, a Bidder ID, an amount, and an auction item name. The system may use data from such records to auto-populate message bodies in creating customized notification messages.

The notification type may identify a type of notification, such as but not limited to: new auction item announcement, outbid notification, additional information broadcast about an auction item, announcement of what charity receives proceeds from a winning bid associated with an auction item, announcement of winning bid/bidder, and the like and combinations thereof. The record may identify various notification types by an ID number, name, or other identification schema. Notification types may include rules and/or standards about what data types/structures/elements they include and/or what kind of messaging must accompany the notification, including but not limited to hyperlinks and other operational tools. As a non-limiting example, the new auction announcement notification type might include a name and/or lot number of the auction item to be announced along with a starting bid and/or reserve amount.

The Bidder ID may reference one or more bidders and/or groups of bidders that are to be notified. They may be referenced by name, Bidder ID number, account number or otherwise, as determined by the setup of the system. The Bidder ID may be used by the system to lookup a bidder account associated therewith to retrieve a personality type so that the notification may be customized to the bidder.

The amount may be one or more amounts associated with the notification type, such as but not limited to a new bid amount, a reserve amount, an amount to be donated to charity, and the like and combinations thereof.

The Auction Item Name may include one or more identifying or informational characteristics about the auction item that is the subject of the announcement. It may include a name of the item, a lot number, an item description or other such similar information. The system may use that information to provide clear customized notifications to bidders.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of operating an auction over a computerized network, comprising the steps of:
a. requesting personality data from a bidder through a user interface;
b. analyzing received personality data, using a processor, from the bidder to determine a personality type from a set of personality types;
c. associating the determined personality type to a bidder account within a computerized auction system hat is assigned to the bidder;
d. providing a computerized library of notification messages that include a multiplicity of notification messages for auctions that each include information presented according to a communication style that is crafted to promote taking action by a particular personality type and associated within the computerized library with that particular personality type;
e. automatically generating a notification for the bidder based on an event that occurs within the computerized auction system;
f. automatically generating a custom notification message for the bidder from the computerized library of notification messages based on the notification in combination with the determined personality type of the bidder; and
g. presenting the custom notification message to the bidder over a user interface.

2. The method of claim 1, further comprising the steps of:
a. receiving a first bid notification for an auction item from the bidder over a computerized network;
b. posting the bid notification to the auction item within the computerized auction system and updating a bid amount;
c. receiving a second bid notification from another bidder that outbids the hid amount;
d. posting the second bid notification to the auction item within the computerized auction system and updating the bid amount; and
e. wherein the selected notification message is a message that notifies the bidder that they have been outbid on the auction item.

3. The method of claim 1, further comprising matching bidders of similar personality types together and providing communication over the computerized network between them during an auction.

4. The method of claim 1, wherein, on the event of a bidder being outbid or losing a bid for an auction item, the computerized auction system automatically sends a request to the bidder to allow their bid amount to go to a charity.

5. The method of claim 1, wherein the computerized library of notification messages includes notification messages that notify a bidder that they have been outbid and are crafted to promote taking the action of placing another bid that is higher than a current bid.

6. The method of claim 1, wherein the notification includes the bidder as a notification recipient and includes: notification data, a notification type, and identifies the bidder as a notification recipient.

7. The method of claim 6, wherein the step of automatically generating a custom notification message for the bidder further includes selecting a notification message from the computerized library based on a query of notification type in combination with the determined personality type of the bidder and automatically combining notification data into the selected notification message.

8. The method of claim 1, wherein the event is the bidder being outbid on the auction item.

9. The method of claim 1, wherein the custom notification message includes computer readable instructions for changing a format of a user interface.

10. A method of operating an auction over a computerized network, comprising the steps of:
a. requesting personality data from a bidder through a user interface;
b. analyzing received personality data, using a processor, from the bidder to determine a personality type from a set of personality types;
c. associating the determined personality type to a bidder account within a computerized auction system that is assigned to the bidder;
d. providing a computerized library of notification messages that include a multiplicity of notification messages for auctions that each include information presented according to a communication style, including message presentation formatting, that is crafted to promote taking mon by a particular personality type and associated within the computerized library with that particular personality type;
e. automatically generating a notification for the bidder based on an event that occurs within the computerized auction system, wherein the notification includes the bidder as a notification recipient and includes: notification data, a notification type, and identifies the bidder as a notification recipient;
f. automatically generating a custom notification message for the bidder from the computerized library of notification messages based on the notification in combination with the determined personality type of the bidder by selecting a notification message from the computerized library based on a query of notification type in combination with the determined personality type of the bidder and automatically combining notification data into the selected notification message; and
g. presenting the custom notification message to the bidder over a user interface.

10. method of claim 10, further comprising the steps of:
a. receiving a first bid notification for an auction item from the bidder over a computerized network;
b. posting the bid notification to the auction item within the computerized auction system and updating a bid amount;
c. receiving a second bid notification from another bidder that outbids the bid amount;
d. posting the second bid notification to the auction item within the computerized auction system and updating the bid amount; and
e. wherein the selected notification message is a message that notifies the bidder that they have been outbid on the auction item.

12. The method of claim 11, wherein the computerized library of notification messages includes notification messages that notify a bidder that they have been outbid and are crafted to promote taking the action of placing another bid that is higher than a current bid.

13. The method of claim 12, wherein the custom notification message includes computer readable instructions for changing a format of a user interface.

14. An auction management system operating over a computerized network, comprising:
a. a computerized library of notification messages that include a multiplicity of notification messages for auctions that each include information presented according to a communication style that is crafted to promote taking action by a particular personality type and associated within the computerized library with that particular personality type;
b. a personality assessment tool that automatically queries the plurality of bidders for personality type information over the computerized network, analyzes bidder responses, and determines personality types based on the responses; and
c. a computerized auction system functionally coupled to the computerized library and to the personality assessment tool that
i. manages a bidder account for each bidder,
ii. records the determined personality types in association with their respective bidder accounts, and
iii. performs an auction over the computerized network by communicating customized notification messages related to the auction to the plurality of bidders, wherein the customized notification messages are generated automatically by the computerized auction system based on a return from the computerized library based on notification type in combination with the determined personality type of the bidder to receive the customized notification message.

15. The system of claim 14, wherein the customized notification messages notify bidders that they have been outbid and are selected to increase the probability that a bidder increases their bid.

16. The system of claim 14, wherein the personality types are selected from the group of personality types consisting of those presented by the DISC and Hermann Brain Dominance models.

17. The system of claim 14, wherein the personality assessment tool determines if a bidder is responsive to competitive statements and if so the computerized auction system automatically generates customized notification messages that include competitive statements therein.

18. The system of claim 14, wherein the computerized auction system automatically aggregates bidder personality type information and provides it to an auction host.

19. The system of claim 14, further comprising a chat tool that permits bidders to chat with each other.

14. system of claim 14, wherein, on the event of a bidder being outbid or losing a bid for an auction item, the computerized auction system automatically sends a request to the bidder to allow their bid amount to go to a charity.
